(19) United States
(12) Patent Application Publication
(10) Pub. No.: US 2023/0074196 A1
(43) Pub. Date: Mar. 9, 2023

(54) METHOD FOR PREPARING BUTYRONITRILE RUBBER POWDER-BASED PVC THERMOPLASTIC ELASTOMER AND USE OF BUTYRONITRILE RUBBER POWDER-BASED PVC THERMOPLASTIC ELASTOMER IN PREPARING AUTOMOTIVE PARTS

(71) Applicant: XUZHOU COLLEGE OF INDUSTRIAL TECHNOLOGY, XUZHOU (CN)

(72) Inventors: YANQIU WANG, XUZHOU (CN); YANAN ZANG, XUZHOU (CN); FENG LIU, XUZHOU (CN); LIANG YAO, XUZHOU (CN); TAICHUANG LIU, XUZHOU (CN); GUOWEN WENG, XUZHOU (CN); XIAOPING ZHANG, XUZHOU (CN)

(21) Appl. No.: 17/870,295

(22) Filed: Jul. 21, 2022

(30) Foreign Application Priority Data
Aug. 18, 2021 (CN) 2021109491865

(51) Int. Cl. C08L 17/00

(52) U.S. Cl. CPC C08L 17/00; C08L 2207/04; C08L 2207/20; C08L 2205/035; C08L 2205/08; C08L 2201/08; C08L 2312/00

(57) ABSTRACT

A method for preparing a butyronitrile rubber powder-based polyvinyl chloride (PVC) thermoplastic elastomer and a use of the butyronitrile rubber powder-based PVC thermoplastic elastomer in preparing automotive parts are provided. The method includes: activating a wasted nitrile butadiene rubber (NBR) powder; plasticizing one of NBR and chloroprene rubber (CR) to obtain a plasticized rubber; dispersing the activated NBR fine rubber powder with one of PVC and chlorinated polyethylene (CPE) in a kneader evenly to obtain a mixture; adding the mixture and pine tar into the plasticized rubber, then mixing evenly to obtain a mixed plastic; adding various compounding agents into the mixed plastic and dispersing evenly to perform cross-linking reaction, thereby obtaining the butyronitrile rubber powder-based PVC thermoplastic elastomer. By using the wasted NBR powder as a main material, which turns waste into treasure and has low cost, and the butyronitrile rubber powder-based PVC thermoplastic elastomer has excellent comprehensive performance.

### TECHNICAL FIELD

The disclosure belongs to a field of polymer material preparation technologies, relates to a preparation of a thermoplastic elastomer, and more particularly to a method for preparing a butyronitrile rubber powder-based polyvinyl chloride (PVC) thermoplastic elastomer and a use of the butyronitrile rubber powder-based PVC thermoplastic elastomer in preparing automotive parts.

### BACKGROUND

A thermoplastic elastomer has occupied an increasingly important position among rubber products, and therefore, a demand for the thermoplastic elastomer has also increased significantly. In order to reduce costs of the thermoplastic elastomer and promote a use of the thermoplastic elastomer, rubber powder-based thermoplastic elastomer (RPTPE) has been developed. The RPTPE is prepared by blending a rubber powder with thermoplastic resin, which has advantages of simple processing and low processing cost. In addition, the rubber powder is in low cost and large amount (generally 50% to 90% of total weight), which can significantly reduce costs of the thermoplastic elastomer. Moreover, the rubber powder can be made from wasted rubber products, which provides a new way to solve the “black” pollution—wasted rubber. Furthermore, the thermoplastic elastomer can be recycled, which is in line with China's sustainable development path. Therefore, the RPTPE has a promising development prospect.

At present, there are some common problems in a preparation of the RPTPE, such as poor mechanical property, poor performance stability, high price and strong odor, which is unsuitable for making high-end products.

### SUMMARY

An object of the disclosure is to provide a method for preparing a butyronitrile rubber powder-based PVC thermoplastic elastomer, which has advantages of lower cost and excellent performance.

Another object of the disclosure is to provide a use of the butyronitrile rubber powder-based PVC thermoplastic elastomer made in the above method in preparing automotive parts.

In order to achieve the above objects, the disclosure provides the following technical solutions.

On the one hand, the disclosure provides a method for preparing a butyronitrile rubber powder-based PVC thermoplastic elastomer, the butyronitrile rubber powder-based PVC thermoplastic elastomer includes: raw materials in parts by weight as follows:

one of PVC and chlorinated polyethylene (CPE) with 15 to 20 parts by weight;

one of nitrile butadiene rubber (NBR) and chloroprene rubber (CR) with 15 to 20 parts by weight;

a wasted NBR powder with 60 to 70 parts by weight; a regenerant with 2 parts by weight, the regenerant may be regenerant WR-510;

pine tar with 15 parts by weight;

a compatibilizer with 0.8 to 1.3 parts by weight;

a vulcanizing agent with 0.3 parts by weight;

a zinc oxide with 5 parts by weight;

a steric acid with 0.3 parts by weight; and

an antioxidant 1010 (i.e., pentaerythritol tetrakys 3-(3,5-ditert-butyl-4-hydroxyphenyl) propionate) with 0.3 parts by weight;

the method includes:

adding the regenerant to the wasted NBR powder and activating for 30 min at 200° C. to obtain an activated NBR fine rubber powder;

plasticizing the one of the NBR and CR at room temperature for 5 min to obtain a plasticized rubber; dispersing the activated NBR fine rubber powder with the one of the PVC and the CPE in a kneader evenly to obtain a mixture; adding the mixture and the pine tar into the plasticized rubber at a range of 160° C. to 165° C., and then mixing evenly to obtain a mixed plastic;

adding the vulcanizing agent, the compatibilizer, the zinc oxide (ZnO), the stearic acid, and the antioxidant 1010 to the mixed plastic, and dispersing evenly in a twin-screw extruder at 180° C. to perform cross-linking reaction with a help of a dynamic cross-linking system and a strong mechanical shear stress, thereby obtaining the butyronitrile rubber powder-based PVC thermoplastic elastomer, and molding into sheets.

In an illustrated embodiment of the disclosure, a particle size of the wasted NBR powder is equal to or greater than 100 meshes.

In an illustrated embodiment of the disclosure, the one of the PVC and the CPE is powdered.

In an illustrated embodiment of the disclosure, the vulcanizing agent is sulfur (S₈).

In an illustrated embodiment of the disclosure, the compatibilizer is bis (tert-butyldioxyisopropl) benzene (BIBP).

In an illustrated embodiment of the disclosure, a length-to-diameter ratio of a screw of the twin-screw extruder is 26 and a compression ratio of the screw of the twin-screw extruder is 3.

On the other hand, the disclosure further provides a use of the butyronitrile rubber powder-based PVC thermoplastic elastomer prepared by the method in preparing automotive parts such as fuel line seals.

Compared with the related art, the disclosure has the advantages that:

(1) A tensile strength of the butyronitrile rubber powder-based PVC thermoplastic elastomer of disclosure reaches 9.8 MPa, elongation at tear reaches 323%, shore hardness is at a range of 52 to 67, compression set is at a range of 17.68 to 23.84, water resistance is at a range of 6.91 to 7.86, oil resistance is at a range of −0.14 to 7.71, a hardness change of thermal and oxygen aging is at a range of +1 to +5, a strength change rate of thermal and oxygen aging is at a range of −4.85 to 5.69, an elongation change rate of thermal and oxygen aging is at a range of 4.66 to 11.18, and the butyronitrile rubber powder-based PVC thermoplastic elastomer is ozone aging resistant, in excellent performance, and no cracks.

(2) The disclosure uses the activated NBR powder, which is equal to or greater than 100 meshes. Compared with raw NBR, the NBR powder is easier to disperse with the one of the PVC and the CPE evenly, harder to stick to the screw in the dynamic cross-linking reaction, more environmentally friendly and pollution-free. The butyronitrile rubber powder-based PVC thermoplastic elastomer has excellent comprehensive performance and can be used in preparing automotive parts.

(3) The disclosure makes full use of dispersible property of the wasted rubber powder, solves environmental pollution caused by discarding the wasted NBR directly, makes the wasted NBR turn into a treasure, and reduces raw materials cost by more than 50%.

### DETAILED DESCRIPTION OF EMBODIMENTS

The disclosure is further explained in conjunction with specific embodiments.

Embodiment 1

Adding 0.3 Kg regenerant to 19.5 Kg wasted NBR powder, which is equal to or greater than 100 meshes and activating for 30 min at 200° C.

Plasticizing 6.0 Kg NBR at room temperature for 5 min to obtain a NBR plasticized rubber; dispersing the activated NBR fine rubber powder with 4.5 Kg PVC powder in a kneader evenly to obtain a mixture; adding the mixture and 4.5 Kg pine tar into the NBR plasticized rubber at a range of 160° C. to 165° C., and then mixing evenly to obtain a mixed plastic.

Adding 0.09 Kg sulfur, 0.33 Kg BIBP, 1.5 Kg zinc oxide, 0.09 Kg stearic acid, 0.09 Kg antioxidant 1010 to the mixed plastic and dispersing evenly in a twin-screw extruder (a length-to-diameter ratio of a screw is 26, compression ratio of the screw is 3) at 180° C. to perform cross-linking reaction with a help of a dynamic cross-linking system and a mechanical shear stress, thereby obtaining a butyronitrile rubber powder-based PVC thermoplastic elastomer and molding into sheets.

Embodiment 2

Adding 0.3 Kg regenerant to 19.5 Kg wasted NBR powder, which is equal to or greater than 100 meshes and activating for 30 min at 200° C.

Plasticizing 4.5 Kg NBR at room temperature for 5 min to obtain a NBR plasticized rubber; dispersing the activated NBR fine rubber powder with 6.0 Kg PVC powder in a kneader evenly to obtain a mixture; adding the mixture and 4.5 Kg pine tar into the NBR plasticized rubber at a range of 160° C. to 165° C., and then mixing evenly to obtain a mixed plastic.

Adding 0.09 Kg sulfur, 0.33 Kg BIBP, 1.5 Kg zinc oxide, 0.09 Kg stearic acid, 0.09 Kg antioxidant 1010 to the mixed plastic and dispersing evenly in a twin-screw extruder (a length-to-diameter ratio of a screw is 26, a compression ratio of the screw is 3) at 180° C. to perform cross-linking reaction with a help of a dynamic cross-linking system and a mechanical shear stress, thereby obtaining a butyronitrile rubber powder-based PVC thermoplastic elastomer and molding into sheets.

Embodiment 3

Adding 0.3 Kg regenerant to 19.5 Kg wasted NBR powder, which is equal to or greater than 100 meshes and activating for 30 min at 200° C.

Plasticizing 6.0 Kg CR at room temperature for 5 min to obtain a CR plasticized rubber; dispersing the activated NBR fine rubber powder with 4.5 Kg CPE powder in a kneader evenly to obtain a mixture; adding the mixture and 4.5 Kg pine tar into the CR plasticized rubber at a range of 160° C. to 165° C., and then mixing evenly to obtain a mixed plastic.

Adding 0.09 Kg sulfur, 0.33 Kg BIBP, 1.5 Kg zinc oxide, 0.09 Kg stearic acid, 0.09 Kg antioxidant 1010 to the mixed plastic and dispersing evenly in a twin-screw extruder (a length-to-diameter ratio of a screw is 26, a compression ratio of the screw is 3) at 180° C. to perform cross-linking reaction with a help of a dynamic cross-linking system and a mechanical shear stress, thereby obtaining a butyronitrile rubber powder-based PVC thermoplastic elastomer and molding into sheets.

Test of performance of the butyronitrile rubber powder-based PVC thermoplastic elastomers respectively made in embodiments 1-3 according to GB/T21874-2008 includes results as follows.

TABLE 1
performance of the butyronitrile rubber powder-based PVC thermoplastic elastomer

| | Embodiments | | | |
|---|---|---|---|---|
| Testing items | GB/T21874-2008 | Embodiment 1 | Embodiment 2 | Embodiment 3 |
| Shore Hardness | 50 ± 5 ≤ Hardness ≤ 70 ± 5 | 61 | 67 | 56 |
| Tensile Strength/MPa | ≥3.0 | 8.05 | 9.82 | 4.18 |
| Elongation at Tear/% | ≥300 | 323 | 301 | 312 |
| Compression set of | ≤25 | 23.84 | 22.56 | 17.68 |
| treating with 23° C. | | | | |
| for 72 h/% | | | | |
| max and min hardness | ±5 | +5 | +5 | +5 |
| changes, max and min | ±10 | +2.02 | −3.59 | −0.77 |
| strength change | ±15 | +0.59 | +10.08 | +3.34 |
| rates, max and min | | | | |
| elongation change | | | | |
| rates of thermal and | | | | |
| oxygen aging test at | | | | |
| 70° C. for 7 days | | | | |
| Ozone resistance | No cracks when observed | No cracks | No cracks | No cracks |
| | under unmagnified conditions | | | |
| Volume change in | −1~+8 | +7.86 | +7.52 | +7.92 |
| water at 70° C. for | | | | |
| 7 days/% | | | | |
| Volume change in | −10~+50 | +0.45 | −0.14 | +7.71 |
| No. 1 standard oil | | | | |
| at 70° C. for 72 h/% | | | | |

As can be seen from Table 1, performance indexes of the butyronitrile rubber powder-based PVC thermoplastic elastomer made by the method far exceed and meet requirements of the international standard GB/T21874-2008 “Elastomeric seals-Requirements for materials for pipe joint seals used in water and drainage applications-Thermoplastic elastomers”, which indicates that the butyronitrile rubber powder-based PVC thermoplastic elastomer made by the method can be used in producing automotive parts, such as fuel pipe seals.

What is claimed is:

1. A method for preparing a butyronitrile rubber powder-based polyvinyl chloride (PVC) thermoplastic elastomer, wherein the butyronitrile rubber powder-based PVC thermoplastic elastomer comprises: raw materials in parts by weight as follows:
one of PVC and chlorinated polyethylene (CPE) with 15 to 20 parts by weight;
one of nitrile butadiene rubber (NBR) and chloroprene rubber (CR) with 15 to 20 parts by weight;
a wasted NBR powder with 60 to 70 parts by weight;
a regenerant with 2 parts by weight;
pine tar with 15 parts by weight;
a compatibilizer with 0.8 to 1.3 parts by weight;
a vulcanizing agent with 0.3 parts by weight;
a zinc oxide with 5 parts by weight;
a steric acid with 0.3 parts by weight; and
an antioxidant 1010 with 0.3 parts by weight;
wherein the method comprises:
adding the regenerant to the wasted NBR powder and activating for 30 min at 200° C. to obtain an activated NBR fine rubber powder;
plasticizing the one of the NBR and CR at room temperature for 5 min to obtain a plasticized rubber; dispersing the activated NBR fine rubber powder with the one of the PVC and the CPE in a kneader evenly to obtain a mixture; adding the mixture and the pine tar into the plasticized rubber at a range of 160° C. to 165° C., and then mixing evenly to obtain a mixed plastic;
adding the vulcanizing agent, the compatibilizer, the zinc oxide, the stearic acid and the antioxidant 1010 to the mixed plastic and dispersing evenly in a twin-screw extruder at 180° C. to perform cross-linking reaction with a help of a dynamic cross-linking system and a mechanical shear stress, thereby obtaining the butyronitrile rubber powder-based PVC thermoplastic elastomer and molding into sheets.

2. The method according to claim 1, wherein a particle size of the wasted NBR powder is equal to or greater than 100 meshes.

3. The method according to claim 1, wherein the one of the PVC and the CPE is powdered.

4. The method according to claim 1, wherein the vulcanizing agent is sulfur.

5. The method according to claim 1, wherein the compatibilizer is bis (tert-butyldioxyisopropl) benzene.

6. The method according to claim 1, wherein a length-to-diameter ratio of a screw of the twin-screw extruder is 26 and a compression ratio of the screw of the twin-screw extruder is 3.

7. A use of the butyronitrile rubber powder-based PVC thermoplastic elastomer prepared by the method according to claim 1 in preparing automotive parts.

8. The use according to claim 7, wherein a particle size of the wasted NBR powder is equal to or greater than 100 meshes.

9. The use according to claim 7, wherein the one of the PVC and the CPE is powdered.

10. The use according to claim 7, wherein the vulcanizing agent is sulfur.

11. The use according to claim 7, wherein the compatibilizer is bis (tert-butyldioxyisopropl) benzene.

12. The use according to claim 7, wherein a length-to-diameter ratio of a screw of the twin-screw extruder is 26 and a compression ratio of the screw of the twin-screw extruder is 3.

13. An automotive part, wherein the automotive part is made from the butyronitrile rubber powder-based PVC thermoplastic elastomer prepared by the method according to claim 1.
